(19) United States
(12) Patent Application Publication
(10) Pub. No.: US 2025/0282375 A1
(43) Pub. Date: Sep. 11, 2025

(54) INFORMATION PROCESSING DEVICE, INFORMATION PROCESSING METHOD, AND RECORDING MEDIUM

(71) Applicant: Panasonic Automotive Systems Co., Ltd., Kanagawa (JP)

(72) Inventors: Kohei ASHIDA, Tokyo (JP); Atsushi KOBAYASHI, Kanagawa (JP)

(73) Assignee: Panasonic Automotive Systems Co., Ltd., Kanagawa (JP)

(21) Appl. No.: 19/062,915

(22) Filed: Feb. 25, 2025

(30) Foreign Application Priority Data
Mar. 6, 2024 (JP) 2024-033558
Sep. 19, 2024 (JP) 2024-161920

(51) Int. Cl. B60W 50/14; B60W 30/18

(52) U.S. Cl. CPC B60W 50/14; B60W 30/18163; B60W 2540/225; B60W 2552/10; B60W 2720/10

(57) ABSTRACT

An information processing device includes: an obtainer that obtains first line of sight information that indicates a direction of a line of sight of a driver who is driving a vehicle; a determiner that determines, based on the first line of sight information, whether a time for which the line of sight of the driver is directed to a second lane is longer than or equal to a first time, the second lane being adjacent to a first lane in which the vehicle is traveling; and a controller that performs, when the determiner determines that the time is longer than or equal to the first time, control relating to a lane change to the second lane by the vehicle.

### CROSS REFERENCE TO RELATED APPLICATIONS

The present application is based on and claims priority of Japanese Patent Application No. 2024-033558 filed on Mar. 6, 2024 and Japanese Patent Application No. 2024-161920 filed on Sep. 19, 2024.

### FIELD

The present disclosure relates to information processing devices, information processing methods, and recording media.

### BACKGROUND

Conventionally, there has been a device that performs, when a vehicle in motion makes a lane change, control relating to the lane change, such as assistance for a driver's lane change operation.

Patent Literature (PTL) 1 discloses a lane change assist system that selects one of a plurality of lane change programs, based on a signal from a driver intention detection device that detects a driver's intention of making a lane change.

### CITATION LIST

### Patent Literature

PTL 1: International Publication No. WO 2012/160591

### SUMMARY

However, the device according to PTL 1 can be improved upon.

In view of this, the present disclosure provides, for example, an information processing device capable of improving upon the above related art.

An information processing device according to one aspect of the present disclosure comprising: an obtaining circuit that obtains first line of sight information that indicates a direction of a line of sight of a driver who is driving a vehicle; a determining circuit that determines, based on the first line of sight information, whether a time for which the line of sight of the driver is directed to a second lane is longer than or equal to a first time, the second lane being adjacent to a first lane in which the vehicle is traveling; and a control circuit that performs, when the determining circuit determines that the time is longer than or equal to the first time, control relating to a lane change to the second lane by the vehicle.

An information processing method according to one aspect of the present disclosure comprising: obtaining first line of sight information that indicates a direction of a line of sight of a driver who is driving a vehicle; determining, based on the first line of sight information, whether a time for which the line of sight of the driver is directed to a second lane is longer than or equal to a first time, the second lane being adjacent to a first lane in which the vehicle is traveling; and performing control relating to a lane change to the second lane by the vehicle, when the time is determined as being longer than or equal to the first time.

A recording medium according to one aspect of the present disclosure is a non-transitory computer-readable recording medium having recorded thereon a program for causing a computer to execute the information processing method.

An information processing device etc. according to one aspect of the present disclosure is capable of improving upon the above related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a block diagram illustrating the configuration of an information processing device according to an embodiment.

FIG. 2 is a diagram schematically showing the interior of a vehicle according to the embodiment.

FIG. 3 is a diagram for illustrating a first example of a lane change by the vehicle according to the embodiment.

FIG. 4 is a diagram for illustrating a second example of the lane change by the vehicle according to the embodiment.

FIG. 5 is a diagram for illustrating a third example of the lane change by the vehicle according to the embodiment.

FIG. 6 is a diagram for illustrating a specific example of vehicle control according to the embodiment.

FIG. 7 is a diagram for illustrating a specific example of vehicle control according to the embodiment.

FIG. 8 is a flow chart showing a first example of a procedure for the information processing device according to the embodiment.

FIG. 9 is a flow chart showing a second example of the procedure for the information processing device according to the embodiment.

FIG. 10 is a flow chart showing an example of a basic information processing method according to the embodiment.

### DESCRIPTION OF EMBODIMENT

### (Circumstances Leading to the Present Disclosure)

As stated above, conventionally, there has been a device that performs, when a vehicle in motion makes a lane change, control relating to the lane change, such as assistance for a driver's lane change operation. In the control relating to the lane change, a display device displays, for example, information indicating whether a lane change can be made, determined based on information about vehicles surrounding a vehicle that is to make a lane change.

In the lane change assist system disclosed in PTL 1, a driver's intention is detected based on, for example, a turn signal of a vehicle, a manual switch operated by the driver, and a detection result of a detector that detects, as a sign of starting a lane change, a lateral acceleration or a yaw rate of the vehicle.

In this manner, conventionally, when a lane change is made in a situation in which surrounding vehicles are traveling at a constant speed, such as a highway, a clear intention of making a lane change, such as the detection of the turn signal and the yaw rate, is recognized, and whether a lane change can be made is displayed.

Here, when the driver performs an operation for making a lane change, such as the turn signal, the manual switch, the lateral acceleration or the yaw rate of the vehicle disclosed in PTL 1, the driver himself has usually completed an operation such as safety confirmation. In other words, when the driver clearly indicates the intention of making the lane change as above, the driver has usually confirmed the safety of the surrounding area, and timing to determine the intention of making the lane change may be not appropriate, that is, timing to perform control relating to the lane change to be made after a determination result is obtained may be not appropriate. When the driver performs a lane change operation, it is desired that control relating to the lane change be performed at appropriate timing to avoid obstructing the lane change operation.

In view of this, the inventors have made the present disclosure.

Hereinafter, an embodiment of the present disclosure is described with reference to the drawings. It should be noted that the embodiment described below shows a specific example of the present disclosure. For this reason, numerical values, shapes, materials, constituent elements, and the arrangement and connection of the constituent elements shown in the following embodiment are mere examples, and are not intended to limit the scope of the present disclosure. Accordingly, among the constituent elements in the following embodiment, those not recited in any of the independent claims are described as optional constituent elements.

It should be noted that the respective figures are schematic diagrams and are not necessarily precise illustrations. In addition, in the respective figures, substantially identical constituent elements are given the same reference signs, and overlapping descriptions thereof are omitted or simplified.

Moreover, in this Description, unless otherwise noted, the ordinal such as “first” and “second” does not mean the number or order of constituent elements, and is used for the purpose of avoiding confusion about constituent elements of the same type and distinguishing them from each other.

### Embodiment

### [Configuration]

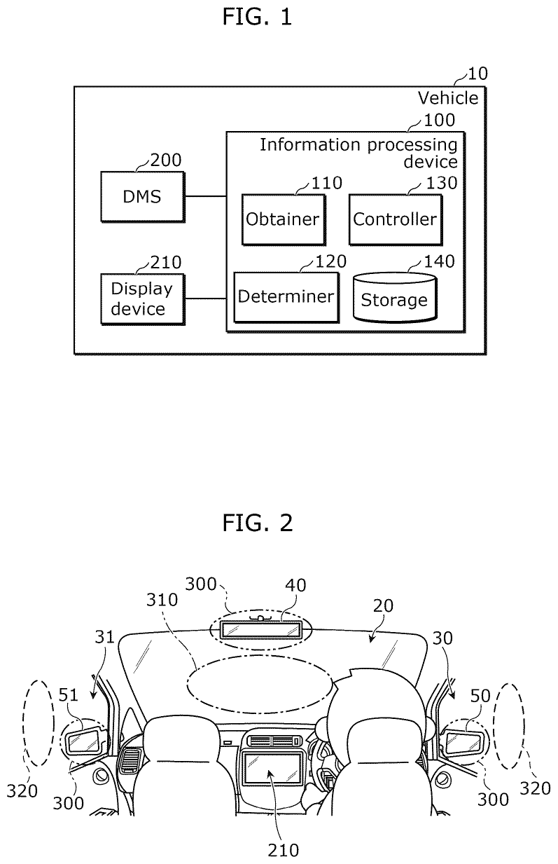

FIG. 1 is a block diagram illustrating the configuration of information processing device 100 according to an embodiment.

Information processing device 100 is a computer that performs control relating to vehicle 10 (hereinafter also referred to as vehicle control). Specifically, information processing device 100 performs vehicle control such as assistance with a lane change in vehicle 10 in motion driven by the driver. Here, the phrase “in motion” means a case in which a vehicle speed is not 0. When the speed of vehicle 10 is 0 (stopped), information processing device 100 does not perform vehicle control such as assistance with a lane change. Such a response by information processing device 100 makes it possible to reduce malfunctions.

Information processing device 100 is disposed in, for example, vehicle 10, and is achieved by, for example, non-volatile memory that stores a program, volatile memory that is a temporary storage region for executing the program, and a processor that executes the program. Information processing device 100 may include a communication interface for communicating with, for example, electronic control units (ECUs) included in vehicle 10 and external servers. The communication interface is achieved by, for example, a wireless communication interface such as an antenna and a wireless communication circuit.

It should be noted that information processing device 100 may be disposed outside vehicle 10. In addition, information processing device 100 may be achieved by, for example, an ECU included in vehicle 10.

Vehicle 10 is, for example, an automobile. For example, DMS 200 that includes an imaging device, a processor, memory, storage, etc., and display device 210 such as a display that displays videos are disposed in vehicle 10. Information processing device 100 is communicably connected to, for example, DMS 200 and display device 210.

DMS 200 is a driver monitoring system (DMS) that captures and monitors the driver. For example, DMS 200 checks a state of the driver, such as a facial orientation and a line of sight of the driver, using the imaging device disposed inside vehicle 10, and estimates whether there is a sign of inattentive driving or drowsy driving. In the present embodiment, DMS 200 captures the face of the driver using the imaging device, calculates a direction of a line of sight of the driver by performing image analysis, and transmits to information processing device 100 a calculation result obtained as line of sight information.

It should be noted that DMS 200 may transmit to information processing device 100 a calculation result as described above as line of sight information, or may transmit to information processing device 100 an image showing the face of the driver as line of sight information. For example, when information processing device 100 obtains an image showing the face of the driver as line of sight information, information processing device 100 may calculate a direction of a line of sight of the driver, based on the image.

Display device 210 is a display that displays videos. Display device 210 displays, for example, a video of vehicle 10 and a video of an area surrounding vehicle 10 by being controlled by information processing device 100. Moreover, for example, display device 210 obtains alert information outputted when DMS 200 detects drowsiness of the driver, and displays a video that urges the driver to take a rest, based on the alert information. Furthermore, for example, display device 210 displays a video obtained from the imaging device included in vehicle 10, a server device outside vehicle 10, or an imaging device disposed outside vehicle 10. In the present embodiment, display device 210 displays information relating to a lane change obtained from information processing device 100.

It should be noted that display device 210 may be a monitor such as a liquid crystal display or may be achieved by a head-up display (HUD).

For example, when information processing device 100 obtains, from DMS 200, line of sight information indicating a direction of a line of sight of the driver, determines whether the driver has an intention of making a lane change, based on the line of sight information obtained, and determines that the driver has the intention of making the lane change, information processing device 100 causes display device 210 to display a video that assists the driver with a lane change operation.

Information processing device 100 includes obtainer 110, determiner 120, controller 130, and storage 140.

Obtainer 110 is a processing unit that obtains various types of information. Specifically, obtainer 110 obtains, from DMS 200, line of sight information indicating a direction of a line of sight of the driver who is driving vehicle 10. It should be noted that the line of sight information may include, in addition to the direction of the line of sight of the driver, information indicating a time at which the direction of the line of sight is detected or information indicating a time for which the direction of the line of sight is held. Additionally, for example, obtainer 110 obtains, from an imaging device etc. included in vehicle 10 and not shown in the figure, a video of an area surrounding vehicle 10.

Determiner 120 is a processing unit that estimates the presence or absence of an intention of the driver to make a lane change. Specifically, determiner 120 determines whether a time for which the line of sight of the driver is directed to an adjacent lane (also referred to as a second lane) adjacent to a lane (also referred to as a first lane) in which vehicle 10 is traveling is longer than or equal to a first time, based on the line of sight information obtained by obtainer 110. In this manner, for example, when the line of sight of the driver is directed to the second lane for at least the first time, determiner 120 determines (estimates) that the driver is trying to make a lane change from the first lane to the second lane. On the other hand, when the line of sight of the driver is not directed to the second lane for at least the first time, determiner 120 determines (estimates) that the driver is not trying to make a lane change from the first lane to the second lane.

It should be noted that the time for which the line of sight of the driver is directed to the second lane may be a time for which the driver is directly looking at the second lane or a time for which the driver is indirectly looking at the second lane in rear-view mirror 40 or side-view mirror 50 or 51.

Moreover, the time for which the line of sight of the driver is directed to the second lane may be a time for which the line of sight of the driver is continuously directed to the second lane or at least a predetermined time for which the line of sight of the driver is directed to the second lane per unit of time. The unit of time and the predetermined time may be determined in any manner in advance, and are not particularly limited.

Controller 130 is a processing unit that performs vehicle control relating to a lane change. Specifically, when the driver is estimated to have an intention of making a lane change, controller 130 assists the driver with a lane change operation of vehicle 10. For example, when determiner 120 determines that the time for which the line of sight of the driver is directed to the second lane is longer than or equal to the first time, controller 130 performs vehicle control relating to a lane change to the second lane by vehicle 10. For example, in the vehicle control relating to the lane change, controller 130 performs at least one of notification relating to the lane change to the driver or control of traveling of vehicle 10. For example, by controlling display device 210, controller 130 performs the notification relating to the lane change to the driver. In addition, for example, controller 130 performs the control of traveling of vehicle 10 by communicating with, for example, ECUs included in vehicle 10 to assist vehicle 10 with acceleration and deceleration, etc.

It should be noted that controller 130 may perform, as the notification relating to the lane change to the driver, the notification relating to the lane change to the driver using sound, by controlling a sound device included in vehicle 10, such as a loudspeaker that outputs sound.

In this manner, controller 130 performs control that assists the driver with the lane change operation, based on a result of the determination made by determiner 120 based on the line of sight information obtained by obtainer 110.

For example, when determiner 120 determines that a time for which the line of sight of the driver is directed to the second lane is longer than or equal to the first time, controller 110 obtains line of sight information indicating a direction of a line of sight of the driver in the second lane after determiner 120 determines that the time is longer than or equal to the first time. Moreover, determiner 120 determines, based on the line of sight information obtained by obtainer 110, a destination in the second lane to which the driver is trying to move vehicle 10 by making the lane change. Furthermore, controller 130 performs control relating to vehicle 10, based on the destination.

It should be noted that line of sight information obtained by obtainer 110 before determiner 120 determines that a time for which the line of sight of the driver is directed to the second lane is longer than or equal to the first time is also referred to as first line of sight information. Additionally, line of sight information obtained by obtainer 110 after determiner 120 determines that the time is longer than or equal to the first time is also referred to as second line of sight information.

FIG. 2 is a diagram schematically showing the interior of vehicle 10 according to the embodiment.

For example, when a line of sight of the driver is directed to first position 300 of rear-view mirror 40 or side-view mirror 50 or 51 included in vehicle 10, determiner 120 determines that the driver is looking at an area behind vehicle 10.

Moreover, for example, when a line of sight of the driver is directed to second position 310 of front window 20 included in vehicle 10, determiner 120 determines that the driver is looking at an area ahead of vehicle 10.

Furthermore, for example, when a line of sight of the driver is directed to third position 320 of door window 30 or 31 included in vehicle 10, determiner 120 determines that the driver is looking at an area lateral to vehicle 10.

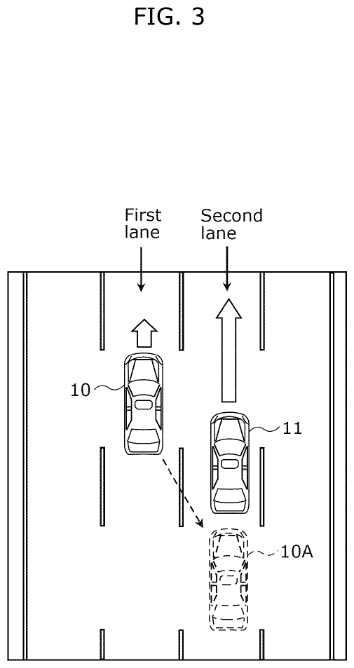

FIG. 3 to FIG. 5 each are a diagram for illustrating a lane change according to the embodiment. It should be noted that FIG. 3 to FIG. 5 each illustrate, as an example, a case in which vehicle 10 is trying to make a lane change from the first lane in which vehicle 10 is traveling to the second lane. Moreover, in the examples shown in FIG. 3 to FIG. 5, another vehicle 11 different from vehicle 10 is traveling in the second lane. Furthermore, an area ahead of and an area behind vehicle 10 in the following description refer to an area ahead of and an area behind a position of vehicle 10 in the second lane, respectively, when vehicle 10 traveling in the first lane is assumed to be traveling in the second lane. Similarly, the area ahead of and the area behind the position of vehicle 10 indicate positions in the second lane.

FIG. 3 is a diagram for illustrating a first example of a lane change by vehicle 10 according to the embodiment.

For example, when determiner 120 determines, based on the second line of sight information, that a line of sight of the driver is directed to an area behind vehicle 10 (specifically, an area behind vehicle 10 in the second lane) for at least the predetermined time, determiner 120 determines an area behind a position of vehicle 10 (specifically, an area behind a position of vehicle 10 in the second lane) as a destination (e.g., destination 10A). It should be noted that the area behind the position of vehicle 10 in the above example means, for example, an area behind a position of vehicle 10 when vehicle 10 in motion continues to travel at a constant speed in the first lane. Moreover, for example, when obtainer 110 obtains a video of an area surrounding vehicle 10, determiner 120 may determine, based on the second line of sight information and the video, that the driver is trying to make a lane change to move vehicle 10 to destination 10A located behind another vehicle 11. For example, when determiner 120 determines that a line of sight of the driver is directed to an area behind vehicle 10 for at least the predetermined time, even though another vehicle 11 is located behind vehicle 10, determiner 120 may determine that the driver is trying to make a lane change to move vehicle 10 to destination 10A located behind another vehicle 11.

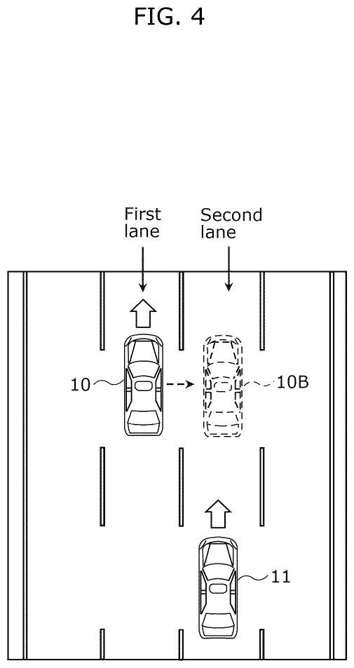

FIG. 4 is a diagram for illustrating a second example of the lane change by vehicle 10 according to the embodiment.

For example, when determiner 120 determines, based on the second line of sight information, that a line of sight of the driver is directed to an area lateral to vehicle 10 for at least the predetermined time, determiner 120 determines an area lateral to a position of vehicle 10 as a destination (e.g., destination 10B). It should be noted that the area lateral to the position of vehicle 10 in the above example means, for example, an area lateral to vehicle 10 when vehicle 10 in motion continues to travel at a constant speed in the first lane. Moreover, for example, when obtainer 110 obtains a video of an area surrounding vehicle 10, determiner 120 may determine, based on the second line of sight information and the video, that the driver is trying to make a lane change to move vehicle 10 to destination 10B located ahead of or behind another vehicle 11. For example, when another vehicle 11 is traveling ahead of vehicle 10, determiner 120 may determine that the driver is trying to make a lane change to move vehicle 10 to an area behind another vehicle 11. Additionally, for example, when another vehicle 11 is traveling behind vehicle 10, determiner 120 may determine that the driver is trying to make a lane change to move vehicle 10 to an area ahead of another vehicle 11.

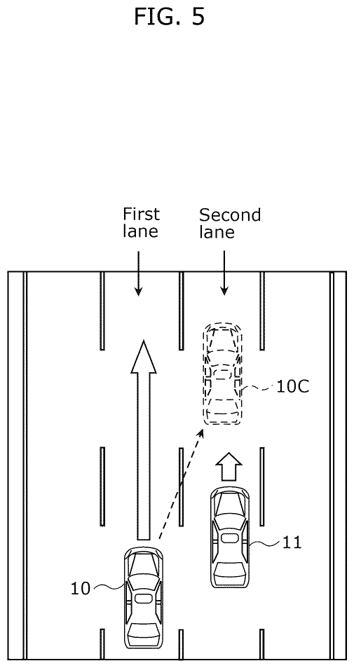

FIG. 5 is a diagram for illustrating a third example of the lane change by vehicle 10 according to the embodiment.

For example, when determiner 120 determines, based on the second line of sight information, that a line of sight of the driver is directed to an area ahead of vehicle 10 (specifically, an area ahead of vehicle 10 in the second lane) for at least the predetermined time, determiner 120 determines an area ahead of a position of vehicle 10 (specifically, an area ahead of a position of vehicle 10 in the second lane) as a destination (e.g., destination 10C). It should be noted that the area ahead of the position of vehicle 10 in the above example means, for example, an area ahead of a position of vehicle 10 when vehicle 10 in motion continues to travel at a constant speed in the first lane. Moreover, for example, when obtainer 110 obtains a video of an area surrounding vehicle 10, determiner 120 may determine, based on the second line of sight information and the video, that the driver is trying to make a lane change to move vehicle 10 to destination 10C located ahead of another vehicle 11. For example, when determiner 120 determines that a line of sight of the driver is directed to an area ahead of vehicle 10 for at least the predetermined time, even though another vehicle 11 is located ahead of vehicle 10, determiner 120 may determine that the driver is trying to make a lane change to move vehicle 10 to destination 10C located ahead of another vehicle 11.

It should be noted that the predetermined time in each of those examples may be determined in any manner in advance, and is not particularly limited. For example, when determiner 120 determines, based on the second line of sight information, that a line of sight of the driver is directed to an area behind vehicle 10 for at least a second time in sum total during a predetermined period, determiner 120 determines, as a destination (e.g., destination 10A), an area behind a position of vehicle 10 when vehicle 10 in motion continues to travel at a constant speed in the first lane. As seen above, for example, the predetermined time may be a cumulative time during the predetermined period. The predetermined period is, for example, a period from when determiner 120 determines that the time for which the line of sight of the driver is directed to the second lane is longer than or equal to the first time. The predetermined period and the second time may be determined in any manner in advance, and are not particularly limited. Moreover, for example, when determiner 120 determines, based on the second line of sight information, that a line of sight of the driver is directed to an area lateral to vehicle 10 for at least the second time in sum total during the predetermined period, determiner 120 determines, as a destination (e.g., destination 10B), an area lateral to a position of vehicle 10 when vehicle 10 in motion continues to travel at a constant speed in the first lane. Furthermore, for example, when determiner 120 determines, based on the second line of sight information, that a line of sight of the driver is directed to an area ahead of vehicle 10 for at least the second time in sum total during the predetermined period, determiner 120 determines, as a destination (e.g., destination 10C), an area ahead of a position of vehicle 10 when vehicle 10 in motion continues to travel at a constant speed in the first lane.

It should be noted that when determiner 120 determines that a line of sight of the driver is directed to neither an area ahead of nor an area lateral to vehicle 10 for at least the second time in sum total during the predetermined period, controller 130 need not perform vehicle control relating to a lane change.

In addition, the predetermined time may be a time for which a line of sight of the driver is continuously directed to one of the area ahead of, the area behind, or the area lateral to vehicle 10 during the predetermined period (specifically, before the predetermined period elapses). For example, when determiner 120 determines, based on the second line of sight information, that a line of sight of the driver is continuously directed to an area behind vehicle 10 for at least a third time, determiner 120 determines, as a destination, an area behind a position of vehicle 10 when vehicle 10 in motion continues to travel at a constant speed in the first lane. Moreover, for example, when determiner 120 determines, based on the second line of sight information, that a line of sight of the driver is continuously directed to an area lateral to vehicle 10 for at least the third time, determiner 120 determines, as a destination, an area lateral to a position of vehicle 10 when vehicle 10 in motion continues to travel at a constant speed in the first lane. Furthermore, for example, when determiner 120 determines, based on the second line of sight information, that a line of sight of the driver is continuously directed to an area ahead of vehicle 10 for at least the third time, determiner 120 determines, as a destination, an area ahead of a position of vehicle 10 when vehicle 10 in motion continues to travel at a constant speed in the first lane.

For example, controller 130 performs vehicle control according to a determination result obtained by determiner 120 as shown in each of those examples. For example, when the driver is trying to move vehicle 10 to an area behind another vehicle 11 as in the first example, controller 130 may perform control that causes vehicle 10 to decelerate. Moreover, for example, when the driver is trying to move vehicle 10 to a lateral area as in the second example, controller 130 may perform control that prevents vehicle 10 from accelerating and decelerating. Moreover, for example, when the driver is trying to move vehicle 10 to an area ahead of another vehicle 11 as in the third example, controller 130 may perform control that causes vehicle 10 to accelerate. These types of the control may be achieved by, for example, controlling the speed of vehicle 10 or may be achieved by giving, to the driver, notification relating the speed of vehicle 10, such as “Please drive faster”.

As stated above, controller 130 may perform vehicle control according to a destination to which the driver is trying to move vehicle 10. For example, controller 130 performs: (i) first control when determiner 120 determines that a line of sight of the driver is directed to an area behind vehicle 10 for at least the second time in sum total during the predetermined period or continuously for at least the third time; (ii) second control when determiner 120 determines that the line of sight of the driver is directed to an area lateral to vehicle 10 for at least the second time in sum total during the predetermined period or continuously for at least the third time, the second control being different from the first control; and (iii) third control when determiner 120 determines that the line of sight of the driver is directed to an area ahead of vehicle 10 for at least the second time in sum total during the predetermined period or continuously for at least the third time, the third control being different from the first control and the second control.

It should be noted that the vehicle control is not limited to the above examples. For example, controller 130 may perform vehicle speed control according to a position of a lane change destination (a destination) of vehicle 10 or may perform driving assistance such as control of the steering wheel included in vehicle 10. Moreover, for example, in the case where the driver is determined as having an intention of making a lane change to an area ahead of vehicle 10, controller 130 may perform driving assistance for supporting acceleration, by causing display device 210 to perform display for urging speeding up of vehicle 10 when vehicle 10 is traveling at a speed slower than a speed of another vehicle 11 traveling in a lane change destination. Furthermore, for example, in the case where the driver is determined as having an intention of making a lane change to an area behind vehicle 10, controller 130 may perform driving assistance for supporting deceleration, by causing display device 210 to perform display for urging speeding down of vehicle 10 when vehicle 10 is traveling at a speed faster than a speed of another vehicle 11 traveling in a lane change destination.

In addition, for example, controller 130 may determine a video that display device 210 is caused to display, based on lane change intention information indicating the presence or absence of an intention of the driver to make a lane change and the number of lanes of a road on which vehicle 10 is traveling.

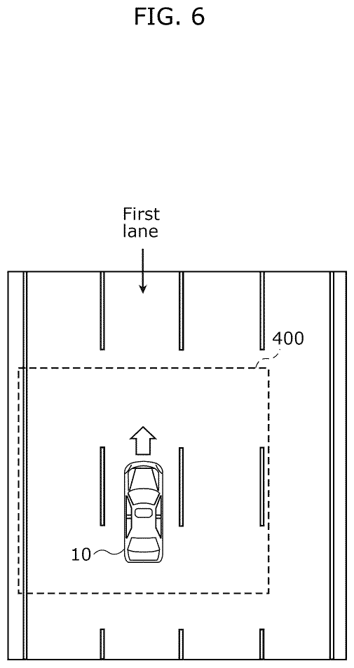

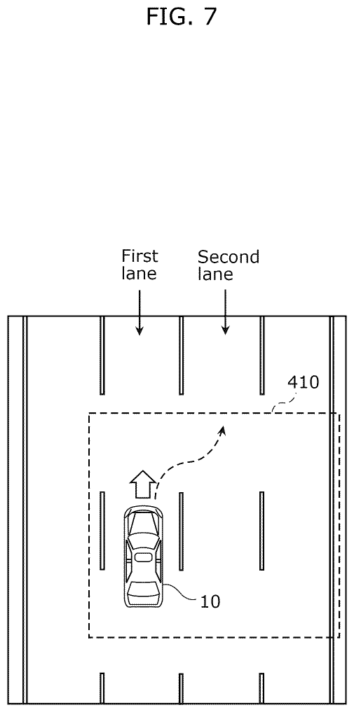

FIG. 6 and FIG. 7 each are a diagram for illustrating a specific example of vehicle control according to the embodiment.

For example, when the driver has no intention of making a lane change from the first lane (i.e., when a time for which a line of sight of the driver is directed to the second lane is less than the first time), as shown in FIG. 6, controller 130 causes display device 210 to display display region 400 including the first lane and lanes that are adjacent to the first lane on both sides. Additionally, for example, when the driver has an intention of making a lane change to the second lane (i.e., when a time for which a line of sight of the driver is directed to the second lane is longer than or equal to the first time), as shown in FIG. 7, controller 130 causes display device 210 to display display region 410 including the second lane and lanes adjacent to the second lane on both sides (i.e., the first lane and a lane that is located opposite the first lane when viewed from the second lane).

It should be noted that these types of videos may be obtained from, for example, an external server device outside vehicle 10. For example, obtainer 110 may obtain, from the external server device, a video according to a determination result obtained by determiner 120. In addition, for example, obtainer 110 may obtain a video of a road that shows all the lanes, and controller 130 may determine a region to be displayed in the video obtained, according to a determination result obtained by determiner 120, and cause display device 210 to display the determined region.

Moreover, for example, when determiner 120 determines that a time for which a line of sight of the driver is directed to the second lane is longer than or equal to the first time, controller 130 may cause display device 210 to display the second lane and surrounding vehicle information about lanes adjacent to the second lane. The surrounding vehicle information is, for example, information that indicates a position, a speed, etc. of another vehicle 11. Furthermore, for example, when determiner 120 determines that the time for which the line of sight of the driver is directed to the second lane is longer than or equal to the first time, controller 130 may cause display device 210 to display information that indicates whether it is possible to make a lane change to the second lane. For example, after controller 130 causes the second lane being displayed by display device 210 to be displayed in a different color from the other lanes or gives, to the driver, notification relating to a clear lane change such as audio guidance, controller 130 may cause display device 210 to display the information indicating whether it is possible to make the lane change to the second lane. For example, controller 130 may control display device 210 to cause the second lane to be in a different display mode (e.g., a color) between when it is possible to make a lane change and when it is not possible to make a lane change. For example, controller 130 performs these types of notification by coloring a lane displayed by display device 210 or performing superimposed display etc. when display device 210 is a HUD. Moreover, for example, in the case where the driver is determined as trying to make a lane change to the second lane, controller 130 may cause display device 210 to display the second lane in a color according to a determination result as to whether it is possible to make a lane change, such as causing display device 210 to display the second lane in blue when it is possible to make a lane change to the second lane or causing display device 210 to display the second lane in red when it is not possible to make the lane change to the second lane.

It should be noted that whether it is possible to make a lane change may be determined by any method. For example, determiner 120 may determine whether it is possible to make a lane change, based on the surrounding vehicle information. In addition, for example, obtainer 110 may obtain, from the external server device, a determination result as to whether it is possible to make a lane change.

Each of the processing units such as obtainer 110, determiner 120, and controller 130 is achieved by, for example, a processor and memory that stores a control program executed by the processor.

Storage 140 is a processing unit that stores various types of information. For example, storage 140 stores information used by each of the processing units, such as threshold information about the above-described predetermined time, the above-described predetermined period, the first time, the second time, and the third time. Storage 140 is achieved by, for example, a hard disk drive or semiconductor memory.

### [Procedure]

Subsequently, a procedure for information processing device 100 is described.

### First Example

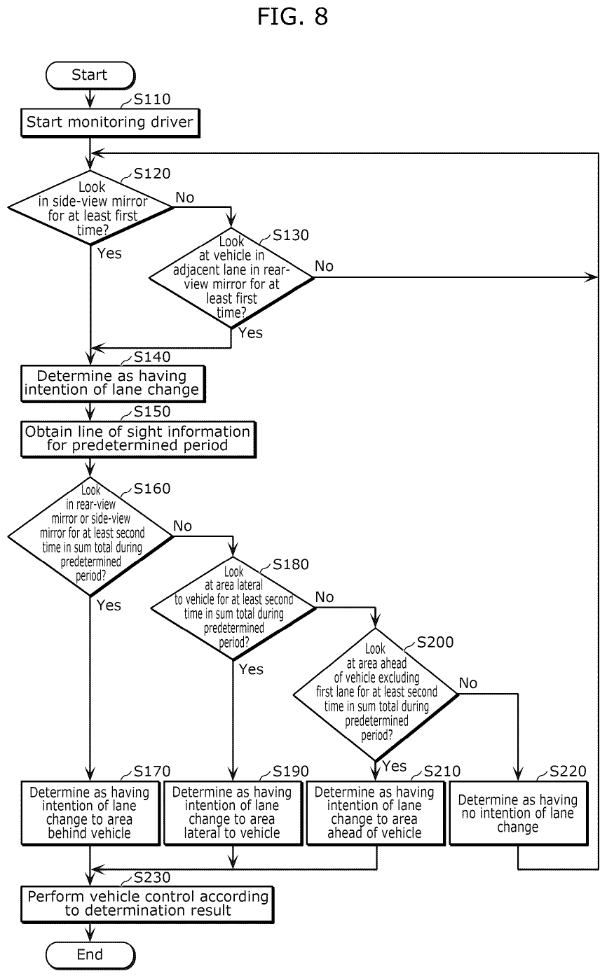

FIG. 8 is a flow chart showing a first example of a procedure for information processing device 100 according to the embodiment. In the first example, when information processing device 100 determines that the driver has an intention of making a lane change, information processing device 100 further estimates that the driver is trying to move vehicle 10 in a direction in which the driver has looked for at least a predetermined time in sum total during a predetermined period.

First, DMS 200 starts monitoring the driver (S110). In the present embodiment, DMS 200 detects a direction of a line of sight of the driver by capturing the face of the driver. Obtainer 110 obtains, from DMS 200, line of sight information (first line of sight information) that indicates the direction of the line of sight of the driver detected by DMS 200.

Next, determiner 120 determines whether the driver has looked in side-view mirror 50 or 51 for at least the first time, based on the line of sight information (S120). Specifically, determiner 120 determines whether the driver has looked at the second lane in side-view mirror 50 or 51 for at least the first time, based on the line of sight information. When determiner 120 determines that the driver has not looked in side-view mirror 50 or 51 for at least the first time (No in S120), determiner 120 determines whether the driver has looked at a vehicle (e.g., another vehicle 11) in an adjacent lane (the second lane) in rear-view mirror 40 for at least the first time (S130). In other words, determiner 120 determines whether the driver has looked at the second lane in rear-view mirror 40 for at least the first time.

When determiner 120 determines that the driver has not looked at the vehicle in rear-view mirror 40 for at least the first time (No in S130), determiner 120 returns the processing to step S120. For example, determiner 120 determines whether the driver has looked at the vehicle in the second lane in rear-view mirror 40 for at least the first time, by performing steps S120 and S130 based on line of sight information repeatedly obtained.

It should be noted that determiner 120 may make a determination in each of steps S120 and S130, based on a time for which the driver has directly looked at the second lane instead of a time for which the driver has indirectly looked at the second lane in rear-view mirror 40 or side-view mirror 50 or 51. Moreover, determiner 120 may determine whether the driver has looked in rear-view mirror 40 or side-view mirror 50 or 51 for at least the first time, or may determine whether the driver has looked at a vehicle in motion in the second lane in rear-view mirror 40 for at least the first time. Furthermore, the first time is, for example, approximately a few seconds such as one to two seconds, but may be determined in any manner.

For example, when determiner 120 determines that the driver has looked in side-view mirror 50 or 51 for at least the first time (Yes in S120) or the driver has looked at the vehicle in the second lane in rear-view mirror 40 for at least the first time (Yes in S130), determiner 120 determines that the driver has an intention of making a lane change from the first lane in which vehicle 10 is traveling to the second lane (S140). Then, determiner 120 determines (estimates) to which part of the second lane the driver is trying to move vehicle 10.

After that, obtainer 110 obtains line of sight information for the predetermined period (second line of sight information that indicates a direction of a line of sight of the driver during a predetermined period) (S150). In this example, for example, the following processes are performed after obtainer 110 obtains the line of sight information for the predetermined period. The predetermined period is, for example, approximately a few seconds such as one to five seconds, but may be determined in any manner.

For example, determiner 120 performs at least one of steps S160, S180, or S200, based on the line of sight information obtained in step S150.

Determiner 120 determines whether the driver has looked in rear-view mirror 40 or side-view mirror 50 or 51 for at least the second time in sum total during the predetermined period (within the predetermined period) (S160). Specifically, determiner 120 determines whether the driver has looked at an area behind vehicle 10 in the second lane in rear-view mirror 40 or side-view mirror 50 or 51 for at least the second time in sum total during the predetermined period.

When determiner 120 determines that the driver has not looked in rear-view mirror 40 or side-view mirror 50 or 51 for at least the second time in sum total during the predetermined period (No in S160), determiner 120 determines whether the driver has looked at an area (e.g., door window 30 or 31) lateral to the vehicle of the driver (i.e., vehicle 10) for at least the second time in sum total during the predetermined period (S180). Specifically, determiner 120 determines whether the driver has looked at an area lateral to vehicle 10 in the second lane for at least the second time in sum total during the predetermined period.

When determiner 120 determines that the driver has not looked at the area lateral to the vehicle of the driver for at least the second time in sum total during the predetermined period (No in S180), determiner 120 determines whether the driver has looked at an area ahead of the vehicle excluding the first lane (e.g., a vehicle traveling ahead of the vehicle of the driver in the second lane or an empty space in the second lane) for at least the second time in sum total during the predetermined period (S200). Specifically, determiner 120 determines whether the driver has looked at an area ahead of vehicle 10 in the second lane for at least the second time in sum total during the predetermined period.

It should be noted that steps S160, S180, and S200 may be performed in any order. Moreover, the second time is, for example, approximately a few seconds such as one to two seconds, but may be determined in any manner. Furthermore, the second time may be determined as a percent of the predetermined period such as at least 50% of the predetermined period or at least 80% of the predetermined period.

When determiner 120 determines that the driver has looked in rear-view mirror 40 or side-view mirror 50 or 51 for at least the second time in sum total during the predetermined period (Yes in S160), determiner 120 determines that the driver has an intention of making a lane change to the area behind the vehicle of the driver (S170). For example, determiner 120 determines that the driver is trying to move vehicle 10 to an area behind a position of vehicle 10 in the second lane when vehicle 10 in motion continues to travel at a constant speed in the first lane.

When determiner 120 determines that the driver has looked at the area lateral to the vehicle of the driver for at least the second time in sum total during the predetermined period (Yes in S180), determiner 120 determines that the driver has an intention of making a lane change to the area lateral to the vehicle of the driver (S190). For example, determiner 120 determines that the driver is trying to move vehicle 10 to an area lateral to vehicle 10 in the second lane when vehicle 10 in motion continues to travel at a constant speed in the first lane.

When determiner 120 determines that the driver has looked at the area ahead of the vehicle of the driver for at least the second time in sum total during the predetermined period (Yes in S200), determiner 120 determines that the driver has an intention of making a lane change to the area ahead of the vehicle of the driver (S210). For example, determiner 120 determines that the driver is trying to move vehicle 10 to an area ahead of a position of vehicle 10 in the second lane when vehicle 10 in motion continues to travel at a constant speed in the first lane.

On the other hand, when determiner 120 determines that the driver has not looked at the area ahead of the vehicle of the driver for at least the second time in sum total during the predetermined period (No in S200), although determiner 120 determines that the driver has an intention of making a lane change, determiner 120 determines that the driver does not make the lane change (lane change operation) (S220), and returns the processing to step S120. In this case, for example, controller 130 does not perform control relating to the lane change, and a determination as to whether the driver has an intention of making a lane change is repeated again.

Next to steps S170, S190, and S210, controller 130 performs vehicle control according to a determination result obtained by determiner 120 (S230). For example, determiner 120 determines that the driver is trying to move vehicle 10 to an area ahead of a position of vehicle 10 in the second lane when vehicle 10 in motion continues to travel at a constant speed in the first lane. For example, when step S230 is performed next to step S170, controller 130 performs vehicle control that assists the driver to move vehicle 10 to an area relatively behind a position of vehicle 10 and the second lane when vehicle 10 in motion continues to travel at a constant speed in the first lane. Moreover, for example, when step S230 is performed next to step S190, controller 130 performs vehicle control that assists the driver to move vehicle 10 to an area relatively lateral to a position of vehicle 10 and the second lane when vehicle 10 in motion continues to travel at a constant speed in the first lane. Furthermore, for example, when step S230 is performed next to step S210, controller 130 performs vehicle control that assists the driver to move vehicle 10 to an area relatively ahead of a position of vehicle 10 and the second lane when vehicle 10 in motion continues to travel at a constant speed in the first lane.

It should be noted that the processes subsequent to step S160 may be performed after obtainer 110 obtains all line of sight information items for the predetermined period in step S150, or step S160 may be performed every time obtainer 110 obtains line of sight information in step S150. In this case, for example, when a determination result is No in any of steps S160, S180, and S200 until the predetermined period elapses, the processing may be returned to step S150. For example, when a determination result is Yes in step S160, S180, or S200 before the predetermined period elapses, the subsequent processes may be performed without returning the processing to step S150. In addition, after the predetermined period elapses, the processes may be performed as shown in FIG. 8.

### Second Example

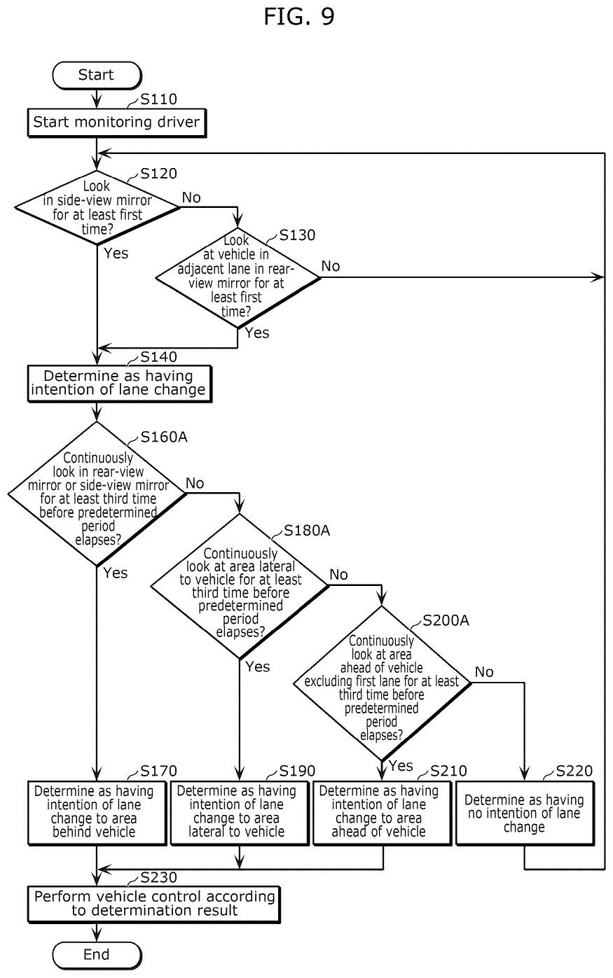

FIG. 9 is a flow chart showing a second example of the procedure for information processing device 100 according to the embodiment. In the second example, when information processing device 100 determines that the driver has an intention of making a lane change, information processing device 100 further estimates that the driver is trying to move vehicle 10 in a direction in which the driver has continuously looked for at least a predetermined time. It should be noted that in the following description of the second example, substantially the same processes as the first example are assigned the same reference signs, and descriptions thereof may be simplified or omitted.

As described in the first example, information processing device 100 performs steps S110 to S140.

Next, obtainer 110 obtains line of sight information (second line of sight information) repeatedly from DMS 200. In the second example, for example, the following processes are performed every time obtainer 110 obtains line of sight information until the predetermined period elapses.

For example, determiner 120 performs at least one of steps S160A, S180A, or S200A below, based on line of sight information obtained after step S140.

Determiner 120 determines whether the driver has continuously looked in rear-view mirror 40 or side-view mirror 50 or 51 for at least the third time before the predetermined period elapses (S160A). Specifically, determiner 120 determines whether the driver has continuously looked at an area behind vehicle 10 in the second lane in rear-view mirror 40 or side-view mirror 50 or 51 for at least the third time before the predetermined period elapses.

Moreover, when determiner 120 determines that the driver has not continuously looked in rear-view mirror 40 or side-view mirror 50 or 51 for at least the third time before the predetermined period elapses (No in S160A), determiner 120 determines whether the driver has continuously looked at an area lateral to the vehicle of the driver for at least the third time before the predetermined period elapses (S180A). Specifically, determiner 120 determines whether the driver has continuously looked at an area lateral to vehicle 10 in the second lane for at least the third time before the predetermined period elapses.

Furthermore, when determiner 120 determines that the driver has not continuously looked at the area lateral to the vehicle of the driver for at least the third time before the predetermined period elapses (No in S180A), determiner 120 determines whether the driver has continuously looked at an area ahead of the vehicle of the driver excluding the first lane for at least the third time before the predetermined period elapses (S200A). Specifically, determiner 120 determines whether the driver has continuously looked at an area ahead of vehicle 10 in the second lane for at least the third time before the predetermined period elapses.

It should be noted that steps S160A, S180A, and S200A may be performed in any order. In addition, the third time is, for example, approximately a few seconds such as one to two seconds, but may be determined in any manner.

Moreover, when determiner 20 determines that the driver has continuously looked in rear-view mirror 40 or side-view mirror 50 or 51 for at least the third time before the predetermined period elapses (Yes in S160A), determiner 120 moves the processing to step S170.

Furthermore, when determiner 20 determines that the driver has continuously looked at the area lateral to the vehicle of the driver for at least the third time before the predetermined period elapses (Yes in S180A), determiner 120 moves the processing to step S190.

Moreover, when determiner 120 determines that the driver has continuously looked at the area ahead of the vehicle of the driver for at least the third time before the predetermined period elapses (Yes in S200A), determiner 120 moves the processing to step S210.

On the other hand, when determiner 120 determines that the driver has not continuously looked at the area ahead of the vehicle of the driver for at least the third time before the predetermined period elapses (No in S200A), determiner 120 moves the processing to step S220.

For example, when a determination result is No in any of steps S160A, S180A, and S200A until the predetermined period elapses, the processing may be returned to step S160A. For example, when a determination result is Yes in step S160A, S180A, or S200A before the predetermined period elapses, the subsequent processes may be performed without returning the processing to step S160A. In addition, after the predetermined period elapses, the processes may be performed as shown in FIG. 9.

It should be noted that the subsequent processes are the same as, for example, those in the procedure shown in FIG. 8.

Moreover, as with the procedure shown in FIG. 8, next to step S140, the processes subsequent to step S160A may be performed after obtainer 110 obtains all line of sight information items for the predetermined period.

### Basic Example

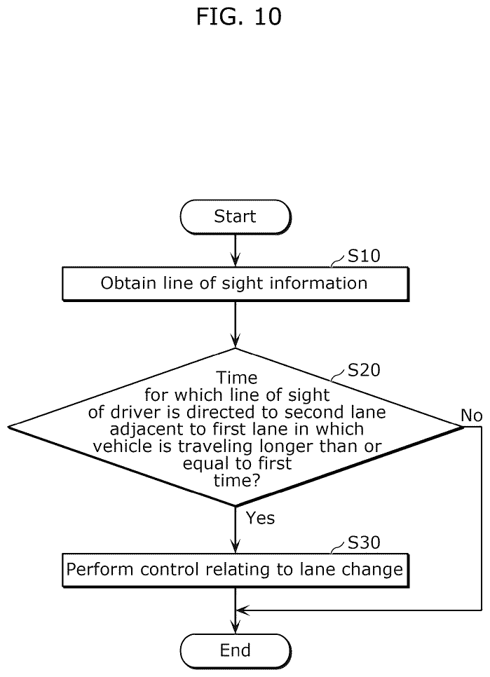

FIG. 10 is a flow chart showing an example of a basic information processing method according to the embodiment. For example, information processing device 100 includes a processor and memory, and the processor performs the following processes using the memory.

First, information processing device 100 obtains line of sight information (first line of sight information) that indicates a direction of a line of sight of the driver who is driving vehicle 10 (S10).

Next, information processing device 100 determines whether a time for which the line of sight of the driver is directed to a second lane adjacent to a first lane in which vehicle 10 is traveling is longer than or equal to the first time, based on the first line of sight information obtained (S20).

When information processing device 100 determines that the time is longer than or equal to the first time in step S20 (Yes in S20), information processing device 100 performs control relating to a lane change to the second lane by vehicle 10 (S30).

On the other hand, when information processing device 100 determines that the time is not longer than or equal to the first time in S20 (No in S20), information processing device 100 does not perform the control relating to the lane change to the second lane by vehicle 10.

Examples of control relating to a lane change include information processing device 100 causing display device 210 to display the first lane and the second lane that is highlighted with a color different from a color of the first lane.

Information processing device 100 performs, for example, the above processes repeatedly when vehicle 10 is in motion.

### Advantageous Effects Etc.

Hereinafter, techniques obtained from the disclosure of the Specification are illustrated, and advantageous effects etc. obtained from the illustrated techniques are described.

Technique 1 is information processing device 100 that includes: obtainer 110 that obtains first line of sight information that indicates a direction of a line of sight of a driver who is driving vehicle 10; determiner 120 that determines, based on the first line of sight information, whether a time for which the line of sight of the driver is directed to a second lane is longer than or equal to a first time, the second lane being adjacent to a first lane in which vehicle 10 is traveling; and controller 130 that performs, when determiner 120 determines that the time is longer than or equal to the first time, control relating to a lane change to the second lane by vehicle 10.

According to this configuration, an intention of the driver to make a lane change is determined based on the direction of the line of sight of the driver. In other words, whether the driver is trying to make a lane change is determined based on the direction of the line of sight of the driver. For this reason, whether the driver is trying to make a lane change is determined long before the driver performs an operation (lane change operation) for making a lane change such as a turn signal as described in PTL 1. To put it another way, whether the driver is trying to make a lane change is determined at timing earlier than ever before. Accordingly, it is possible to prevent control relating to vehicle 10, such as notification relating to a lane change to the driver and control of traveling of vehicle 10, from being performed at already unnecessary timing. As a result, information processing device 100 makes it possible to perform control relating to a lane change at appropriate timing.

Technique 2 is information processing device 100 according to Technique 1, in which in the control relating to the lane change, controller 130 performs at least one of notification relating to the lane change to the driver or control of traveling of vehicle 10.

According to this configuration, the control relating to the lane change makes it possible to assist the driver with the lane change operation.

Technique 3 is information processing device 100 according to Technique 1 or Technique 2, in which when determiner 120 determines that the time is longer than or equal to the first time, obtainer 110 obtains second line of sight information that indicates a direction of a line of sight of the driver in the second lane after determiner 120 determines that the time is longer than or equal to the first time, determiner 120 determines, based on the second line of sight information, a destination (e.g., destination 10A, 10B, or 10C) in the second lane to which the driver is trying to move vehicle 10 by making the lane change, and controller 130 performs control relating to vehicle 10, based on the destination.

According to this configuration, controller 130 makes it possible to perform the control relating to vehicle 10, based on the destination to which the driver is estimated to move vehicle 10.

Technique 4 is information processing device 100 according to Technique 3, in which, based on the second line of sight information, determiner 120: determines, as the destination (e.g., destination 10A), an area behind a position of vehicle 10 in a case where vehicle 10 in motion continues to travel at a constant speed in the first lane, when determiner 120 determines that the line of sight of the driver is directed to an area behind vehicle 10 for at least a second time in sum total during a predetermined period; determines, as the destination (e.g., destination 10B), an area lateral to a position of vehicle 10 in a case where vehicle 10 in motion continues to travel at a constant speed in the first lane, when determiner 120 determines that the line of sight of the driver is directed to an area lateral to vehicle 10 for at least the second time in sum total during the predetermined period; and determines, as the destination (e.g., destination 10C), an area ahead of a position of vehicle 10 in a case where vehicle 10 in motion continues to travel at a constant speed in the first lane, when determiner 120 determines that the line of sight of the driver is directed to an area ahead of vehicle 10 for at least the second time in sum total during the predetermined period.

According to this configuration, it is possible to accurately determine the destination in the second lane to which the driver is trying to move vehicle 10 by performing the lane change operation.

Technique 5 is information processing device 100 according to Technique 3 or Technique 4, in which, based on the second line of sight information, determiner 120: determines, as the destination, an area behind a position of vehicle 10 in a case where vehicle 10 in motion continues to travel at a constant speed in the first lane, when determiner 120 determines that the line of sight of the driver is continuously directed to an area behind vehicle 10 for at least a third time; determines, as the destination, an area lateral to a position of vehicle 10 in a case where vehicle 10 in motion continues to travel at a constant speed in the first lane, when determiner 120 determines that the line of sight of the driver is continuously directed to an area lateral to vehicle 10 for at least the third time; and determines, as the destination, an area ahead of a position of vehicle 10 in a case where vehicle 10 in motion continues to travel at a constant speed in the first lane, when determiner 120 determines that the line of sight of the driver is continuously directed to an area ahead of vehicle 10 for at least the third time.

According to this configuration, it is possible to accurately determine the destination in the second lane to which the driver is trying to move vehicle 10 by performing the lane change operation.

Technique 6 is an information processing method that includes: obtaining first line of sight information that indicates a direction of a line of sight of a driver who is driving vehicle 10 (S10); determining, based on the first line of sight information, whether a time for which the line of sight of the driver is directed to a second lane is longer than or equal to a first time (S20), the second lane being adjacent to a first lane in which vehicle 10 is traveling; and performing control relating to a lane change to the second lane by vehicle 10 (S30), when the time is determined as being longer than or equal to the first time (Yes in S20).

According to this configuration, the same advantageous effects as information processing device 100 according to Technique 1 are achieved.

Technique 7 is a program for causing a computer to execute the information processing method according to Technique 6.

According to this configuration, the same advantageous effects as information processing device 100 according to Technique 1 are achieved.

It should be noted that general or specific aspects of the present disclosure may be realized by a system, a device, a method, an integrated circuit, a computer program, or a computer-readable non-transitory recording medium such as a CD-ROM. In addition, the general or specific aspects of the present disclosure may be realized by any combination of systems, devices, methods, integrated circuits, computer programs, and recording media.

### OTHER EMBODIMENTS

Although the present disclosure has been described above based on each of the embodiments, the present disclosure is not limited to the embodiment. Accordingly, the constituent elements described in the accompanying Drawings and the detailed descriptions may include not only those essential for solving the problems but also those not essential for solving the problems, to illustrate the above techniques. As such, descriptions of these non-essential constituent elements in the accompanying Drawings and the detailed descriptions should not be readily interpreted to mean that these non-essential constituent elements are essential.

For example, in the above-described embodiment, the time for which the line of sight of the driver is directed to the second lane may be a time for which the driver indirectly looks at the second lane via display device 210 (e.g., a HUD) that displays surrounding vehicle information.

Moreover, in the above-described embodiment, each of the constituent elements (each of the processing units) may be achieved by executing a software program suitable for the constituent element. Each constituent element may be achieved by a program executing unit, such as a central processing unit (CPU) or a processor, reading and executing a software program recorded on a recording medium such as a hard disk or semiconductor memory.

Furthermore, each constituent element may be achieved by hardware. The constituent element may also be a circuit (or an integrated circuit). These circuits may be consolidated as a single circuit and, alternatively, may be individual circuits. In addition, these circuits may be ordinary circuits and, alternatively, may be specialized circuits.

Moreover, the division of functional blocks in the block diagram is one example. Multiple functional blocks may be embodied as a single functional block, a single functional block may be divided into multiple functional blocks, or some functions may be moved to other functional blocks. Additionally, the functions of a plurality of functional blocks having similar functions may be processed by a single piece of hardware or software in parallel or by time-division.

Furthermore, the order of executing each step in the flow charts is a mere illustration for specifically describing the present disclosure, and thus may be an order other than the above-described order. In addition, one or more of the above-described steps may be executed simultaneously (in parallel) with another step.

Forms obtained by various modifications to the above-described embodiment that can be conceived by a person skilled in the art as well as forms achieved by combining any of the constituent elements and functions in the above-described embodiment as long as they are within the spirit of the present disclosure are included in the present disclosure.

While various embodiments have been described herein above, it is to be appreciated that various changes in form and detail may be made without departing from the spirit and scope of the present disclosure as presently or hereafter claimed.

### Further Information about Technical Background to this Application

The disclosures of the following patent applications including specification, drawings, and claims are incorporated herein by reference in their entirety: Japanese Patent Application No. 2024-033558 filed on Mar. 6, 2024 and Japanese Patent Application No. 2024-161920 filed on Sep. 19, 2024.

### INDUSTRIAL APPLICABILITY

The present disclosure is applicable to an information processing device that assists a driver with a lane change operation.

1. An information processing device comprising:
an obtaining circuit that obtains first line of sight information that indicates a direction of a line of sight of a driver who is driving a vehicle;
a determining circuit that determines, based on the first line of sight information, whether a time for which the line of sight of the driver is directed to a second lane is longer than or equal to a first time, the second lane being adjacent to a first lane in which the vehicle is traveling; and
a control circuit that performs, when the determining circuit determines that the time is longer than or equal to the first time, control relating to a lane change to the second lane by the vehicle.

2. The information processing device according to claim 1,
wherein in the control relating to the lane change, the control circuit performs at least one of notification relating to the lane change to the driver or control of traveling of the vehicle.

3. The information processing device according to claim 1,
wherein when the determining circuit determines that the time is longer than or equal to the first time, the obtaining circuit obtains second line of sight information that indicates a direction of a line of sight of the driver in the second lane after the determining circuit determines that the time is longer than or equal to the first time,
the determining circuit determines, based on the second line of sight information, a destination in the second lane to which the driver is trying to move the vehicle by making the lane change, and
the control circuit performs control relating to the vehicle, based on the destination.

4. The information processing device according to claim 3,
wherein based on the second line of sight information, the determining circuit:
determines, as the destination, an area behind a position of the vehicle in a case where the vehicle in motion continues to travel at a constant speed in the first lane, when the determining circuit determines that the line of sight of the driver is directed to an area behind the vehicle for at least a second time in sum total during a predetermined period;
determines, as the destination, an area lateral to a position of the vehicle in a case where the vehicle in motion continues to travel at a constant speed in the first lane, when the determining circuit determines that the line of sight of the driver is directed to an area lateral to the vehicle for at least the second time in sum total during the predetermined period; and
determines, as the destination, an area ahead of a position of the vehicle in a case where the vehicle in motion continues to travel at a constant speed in the first lane, when the determining circuit determines that the line of sight of the driver is directed to an area ahead of the vehicle for at least the second time in sum total during the predetermined period.

5. The information processing device according to claim 3,
wherein based on the second line of sight information, the determining circuit:
determines, as the destination, an area behind a position of the vehicle in a case where the vehicle in motion continues to travel at a constant speed in the first lane, when the determining circuit determines that the line of sight of the driver is continuously directed to an area behind the vehicle for at least a third time;
determines, as the destination, an area lateral to a position of the vehicle in a case where the vehicle in motion continues to travel at a constant speed in the first lane, when the determining circuit determines that the line of sight of the driver is continuously directed to an area lateral to the vehicle for at least the third time; and
determines, as the destination, an area ahead of a position of the vehicle in a case where the vehicle in motion continues to travel at a constant speed in the first lane, when the determining circuit determines that the line of sight of the driver is continuously directed to an area ahead of the vehicle for at least the third time.

6. An information processing method comprising:
obtaining first line of sight information that indicates a direction of a line of sight of a driver who is driving a vehicle;
determining, based on the first line of sight information, whether a time for which the line of sight of the driver is directed to a second lane is longer than or equal to a first time, the second lane being adjacent to a first lane in which the vehicle is traveling; and
performing control relating to a lane change to the second lane by the vehicle, when the time is determined as being longer than or equal to the first time.

7. A non-transitory computer-readable recording medium having recorded thereon a program for causing a computer to execute the information processing method according to claim 6.
